(19) United States
(12) Patent Application Publication
(10) Pub. No.: US 2006/0140658 A1
(43) Pub. Date: Jun. 29, 2006

(54) Image forming apparatus, install method, and computer readable recording medium where an install program is recorded

(76) Inventor: Koji Shimizu, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/250,405

(22) Filed: Oct. 17, 2005

(30) Foreign Application Priority Data
Oct. 21, 2004 (JP) 2004-306960
Aug. 18, 2005 (JP) 2005-237850

(51) Int. Cl. G03G 21/14

(52) U.S. Cl. 399/77

(57) ABSTRACT

An image forming apparatus where a program can be installed includes a determination part configured to determine a necessity of confirmation of information with respect to hardware of the image forming apparatus based on the program to be installed, the program stored in a storage medium set in the image forming apparatus or an apparatus connecting to the image forming apparatus via a network, and a hardware confirmation part configured to confirm the information with respect to the hardware in a case where the determination part determines that the information with respect to the hardware is necessary.

### BACKGROUND OF THE INVENTION

1. Field of the Invention

The present invention relates to image forming apparatuses, information processing methods, and computer readable recording media where information processing programs are recorded, and more specifically, to an image forming apparatus such as a copier, printer, scanner, facsimile, multiple function processing machine, or composite apparatus, an install method, and a computer readable recording medium such as an SD memory card where an install program is recorded.

2. Description of the Related Art

Recently, composite apparatuses or Multi Function Peripherals (MFPs) having a copy function or facility, a scanner function or facility and a facsimile function or facility have been marketed. When the composite apparatus or MFP functions as a copying apparatus or a printer, an image is printed on a printing medium such as paper. When the composite apparatus or MFP functions as a copying apparatus or a scanner, an image is read from a document. When the composite apparatus or MFP functions as a facsimile apparatus, an image is set to or received from another apparatus via a telephone line. See Japan Laid-Open Patent Application Publication No. 2000-84383.

On the other hand, these days, an image forming apparatus whereby a Java (registered trademark) program can be implemented has been suggested. High compatibility whereby the same Java program can be implemented by various machines is one of specific features of the Java program. Since there are various kinds of machines in the field of the image forming apparatus, such a specific feature of the Java program is extremely beneficial for the image forming apparatus. In order to implement the same Java program in various kinds of the machines, it is necessary to install Java virtual machines in the machines so that the difference among the machines can be solved. Because of this, it is convenient to not only install the Java virtual machine in the image forming apparatus prior to shipping the image forming apparatus but also to prepare for the situation where the Java virtual machine can be installed in the image forming apparatus after shipping the image forming apparatus. However, there are problems such as how to solve a machine dependency problem of the Java virtual machine.

### SUMMARY OF THE INVENTION

Accordingly, it is a general object of the present invention to provide a novel and useful image forming apparatus, install method, and computer readable recording medium where an install program is recorded, in which one or more of the problems described above are eliminated.

Another and more specific object of the present invention is to provide an image forming apparatus whereby a program proper for various kinds of the image forming apparatus can be properly installed, an install method, and a computer readable recording medium where an install program is recorded.

The above-mentioned object of the present invention is achieved by an image forming apparatus where a program can be installed, including:

a determination part configured to determine a necessity of confirmation of information with respect to hardware of the image forming apparatus based on the program to be installed, the program stored in a storage medium set in the image forming apparatus or an apparatus connecting to the image forming apparatus via a network; and

a hardware confirmation part configured to confirm the information with respect to the hardware in a case where the determination part determines that the information with respect to the hardware is necessary.

According to the above-mentioned image forming apparatus, it is possible to properly install a program proper for various kinds of the image forming apparatus.

The above object of the present invention is also achieved by an install method in an image forming apparatus where a program can be installed, the method including the steps of:

a) determining a necessity of confirmation of information with respect to hardware of the image forming apparatus based on the program to be installed, the program being stored in a storage medium set in the image forming apparatus or an apparatus connecting to the image forming apparatus via a network; and

b) confirming the information with respect to the hardware in a case where it is determined in the step a) that confirming the information with respect to the hardware is necessary.

According to the above-mentioned install method, it is possible to properly install a program proper for various kinds of the image forming apparatus.

The above object of the present invention is achieved by a computer readable recording medium where an install program is recorded, the install program used for installing a program in an image forming apparatus, the install program including the steps of:

a) determining a necessity of confirmation of information with respect to hardware of the image forming apparatus based on the program to be installed, the program being stored in a storage medium set in the image forming apparatus or an apparatus connecting to the image forming apparatus via a network; and

b) confirming the information with respect to the hardware in a case where it is determined in the step a) that the information with respect to the hardware is necessary.

According to the above-mentioned computer readable recording medium, it is possible to properly install a program proper for various kinds of the image forming apparatus.

Other objects, features, and advantages of the present invention will become more apparent from the following detailed description when read in conjunction with the accompanying drawings.

### BRIEF DESCRIPTION OF THE DRAWINGS

FIG. 1 is a schematic view showing an MFP corresponding to an embodiment of the present invention;

FIG. 2 is a view showing a hardware structure of the MFP shown in FIG. 1;

FIG. 3 is a view showing an external appearance of the MFP shown in FIG. 1;

FIG. 4 is a view showing an operations panel;

FIG. 5 is a schematic view showing a composite apparatus starting part;

FIG. 6 is a block diagram showing a software process regarding an SD memory card slot and the SD memory card;

FIG. 7 is a class view of a JSDK platform and a JSDK application of FIG. 1;

FIG. 8 is a functional block view of an SAS of FIG. 1;

FIG. 9 is a block diagram for explaining an install process;

FIG. 10 is a block diagram for explaining an update process;

FIG. 11 is a flowchart of a first example of the install process;

FIG. 12 is a flowchart of a second example of the install process;

FIG. 13 is a flowchart of a third example of the install process;

FIG. 14 is a flowchart of a first example of the update process;

FIG. 15 is a flowchart of a second example of the update process;

FIG. 16 is a flowchart of a third example of the update process;

FIG. 17 is a view of an install operations screen;

FIG. 18 is a view of an update operations screen;

FIG. 19 is a block diagram for explaining machine dependency of CVM of the composite apparatus shown in FIG. 1;

FIG. 20 is a block diagram for explaining a file of the CVM of the composite apparatus shown in FIG. 1;

FIG. 21 is a block diagram for explaining a file of the CVM of the composite apparatus shown in FIG. 1;

FIG. 22 is a flowchart with respect to S114 or S214 of the install process; and

FIG. 23 is a flowchart with respect to S414 or S514 of the update process.

### DETAILED DESCRIPTION OF THE PREFERED EMBODIMENTS

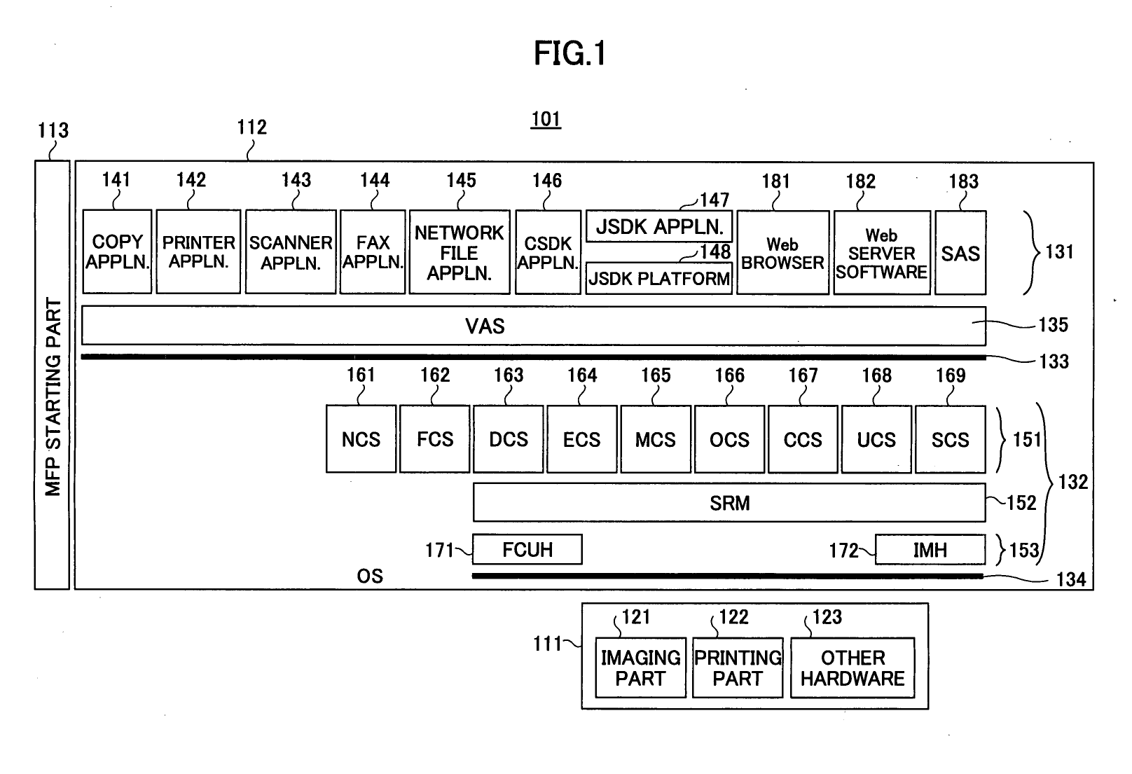

A description of the present invention and details of drawbacks of the related art are now given, with reference to FIG. 1 through FIG. 23, including embodiments of the present invention.

FIG. 1 is a view showing an MFP 101 corresponding to an embodiment of the present invention. The MFP 101 shown in FIG. 1 includes various kinds of hardware 111, various kinds of software 112, and an MFP starting (or booting) part 113.

The hardware 111 of the MFP 101 includes an imaging part 121, a printing part 122, and other hardware 123. The imaging part 121 is hardware for reading an image (image data) from a document. The printing part 122 is hardware for printing an image (image data) on a printing medium such as paper.

The software 112 of the MFP 101 includes various kinds of applications 131 and various kinds of platforms 132. These programs are executed in parallel in units of processes by an Operating System (OS) such as UNIX (registered trademark).

The applications 131 include a copy application 141 for the copy function or facility, a printer application 142 for the printer function or facility, a scanner application 143 for the scanner function or facility, a facsimile application 144 for the facsimile function or facility, and a network file application 145 for the network file function or facility. In addition, a Web browser 181 being software for viewing a Web page, Web server software 182 being software for downloading the Web page, a SDK application service (SAS) 183 being software for controlling a CSDK application 146 and a JSDK application 147 are also provided in the applications 131.

The applications 131 may be developed by use of an exclusive Software Developing Kit (SDK). An application 131 that is developed by use of the SDK will be referred to as an “SDK application”Exclusive SDKs include a “CSDK” for developing an application 131 in the C language, and a “JSDK” for developing an application 131 in the Java language. An application 131 that is developed by use of the CSDK will be referred to as a “CDSK application”, and an application 131 that is developed by use of the JSDK will be referred to as a “JSDK application”A CSDK application 146 and a JSDK application 147 exist in the MFP 101 shown in FIG. 1. The MFP 101 shown in FIG. 1 further includes a JSDK platform 148 as the software 112 that intermediates between the JSDK application 147 that is written in the Java language and the other software 112 that is written in the C language.

The platforms 132 include various kinds of control services 151, a System Resource Manager (SRM) 152, and various kinds of handlers 153. The control services 151 include a Network Control Service (NCS) 161, a Facsimile Control Service (FCS) 162, a Delivery Control Service (DCS) 163, an Engine Control Service (ECS) 164, a Memory Control Service (MCS) 165, an Operations Panel Control Service (OCS) 166, a Certification Control Service (CCS) 167, a User-directory Control Service (UCS) 168, and a System Control Service (SCS) 169. The handlers 153 include a Facsimile Control Unit Handler (FCUH) 171 and an Image Memory Handler (IMH) 172.

The process of the NCS 161 includes mediating the network communication. The process of the FCS 162 includes providing the facsimile API. The process of the DCS 163 includes control related to the stored document distributing process. The process of the ECS 164 includes control related to the imaging part 121 and the printing part 122. The process of the MCS 165 includes control related to the memory and the Hard Disk Drive (HDD). The process of the OCS 166 includes control related to the operations panel. The process of the CCS 167 includes control related to the authentication process and the accounting process. The process of the UCS 168 includes control related to the user information management. The process of the SCS 169 includes control related to the system management.

A Virtual Application Service (VAS) 135, which is one of the software programs 112, mediates between the applications 131 and the platforms 132. The VAS 135 operates as a server process that regards the applications 131 as the client, and operates as a client process that regards the platforms 132 as the server. The VAS 135 includes a wrapping function that conceals the platforms 132 when viewed from the applications 131, and has a role of absorbing a version difference when the version of the platform 132 is upgraded.

The MFP starting point 113 is first executed when the power of the MFP 101 is turned ON. Hence, the OS such as UNIX is started, and the applications 131 and the platforms 132 are started. These programs are stored in the HDD or memory card, reproduced from the HDD or memory card, and loaded into the memory.

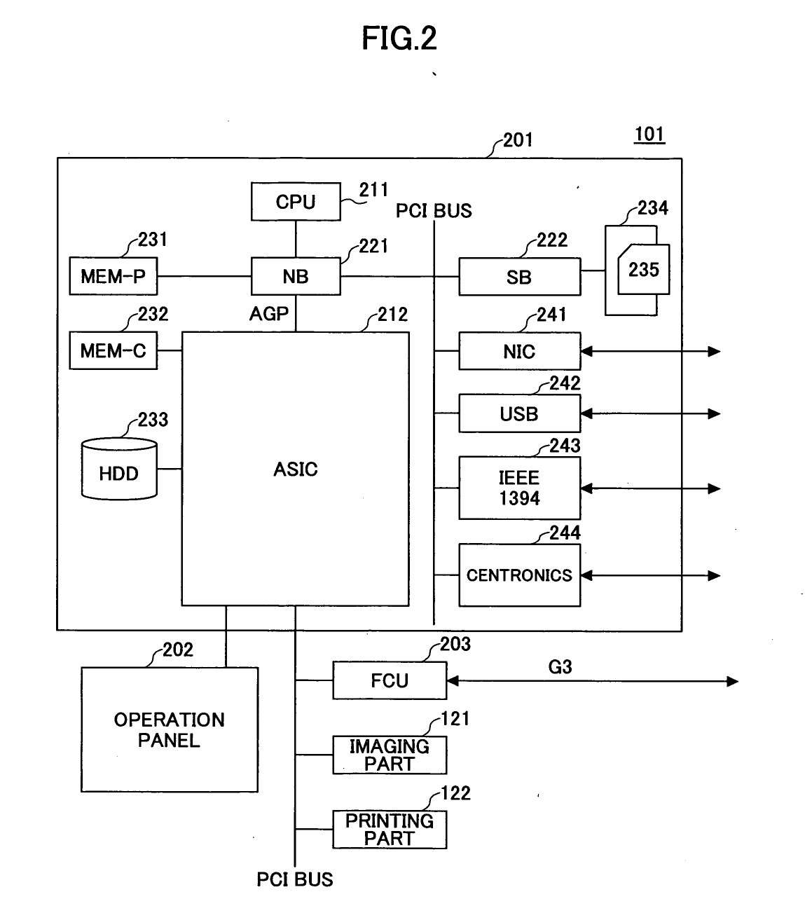

FIG. 2 is a view showing a hardware structure related to the MFP 101 shown in FIG. 1. The hardware 111 of the MFP 101 includes a controller 201, an operations panel 202, a Facsimile Control Unit (FCU) 203, the imaging part 121 and the printing part 122.

The controller 201 includes a CPU 211, an ASIC 212, a North Bridge (NB) 221, a South Bridge (SB) 222, a system memory (MEM-P) 231, a local memory (MEM-C) 232, a HDD 233, a memory card slot 234, a Network Interface Controller (NIC) 241, a USB device 242, an IEEE1 394 device 243, and a Centronics device 244.

The CPU 211 is an IC for processing various kinds of information. The ASIC 212 is an IC for processing various kinds of images. The NB 221 is the north bridge of the controller 201. The SB 222 is the south bridge of the controller 201. The system memory (MEM-P) 231 is the system memory of the MFP 101. The local memory (MEM-C) 232 is the local memory of the MFP 101. The HDD 233 is a storage device of the MFP 101. The memory card slot 234 is a slot for setting a memory card 235. The NIC 241 is a controller for network communication using the MAC address. The USB device 242 is a device for providing connection terminals of the USB standard. The IEEE 1394 device 243 is a device for providing connection terminals of the IEEE 1394 standard. The Centronics device 244 is a device for providing connection terminals of Centronics specifications.

The operations panel 202 forms hardware (operation part) that is operated by an operator to make an input to the MFP 101, and also forms hardware (display part) for the operator to obtain an output from the MFP 101.

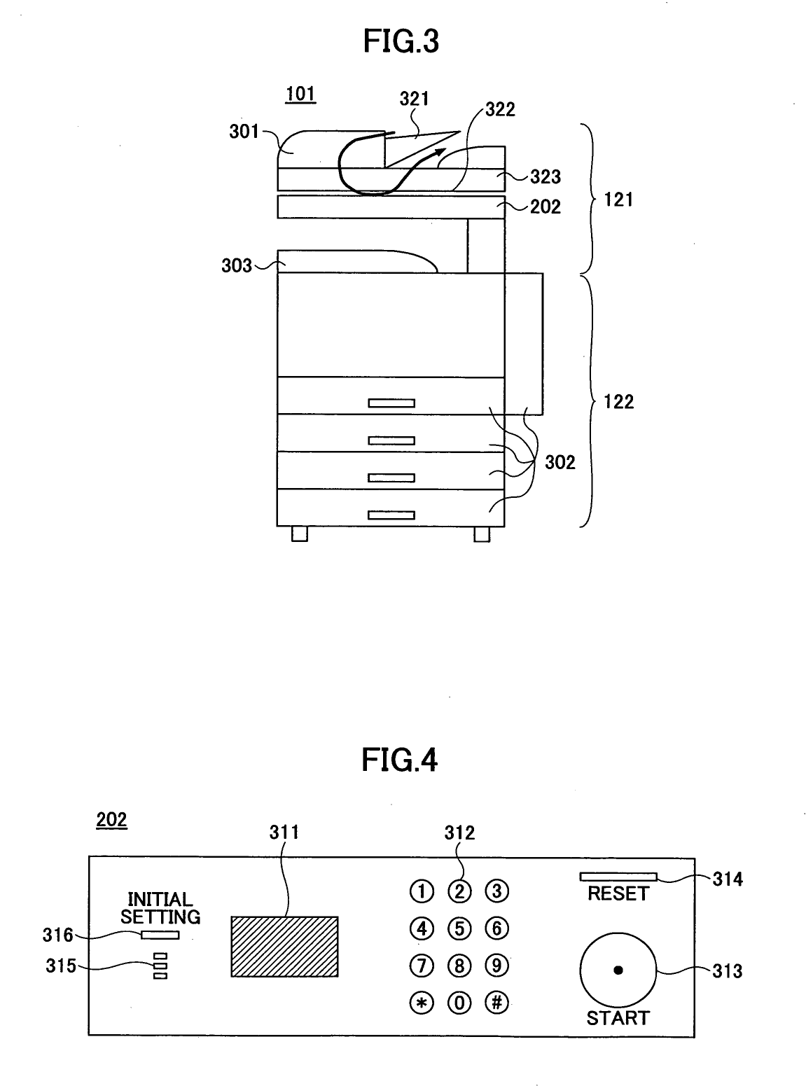

FIG. 3 is a view showing an external appearance of the MFP 101 shown in FIG. 1. FIG. 3 shows a position of the imaging part 121, a position of the printing part 122, and a position of the operations panel 202. FIG. 3 further shows a document set part 301 where the documents to be read are set, a paper supply part 302 from where the printing paper is supplied, and a paper eject part 303 to where the printing paper is ejected.

FIG. 4 is a diagram showing the operations panel 202. As shown in FIG. 4, the operations panel 202 includes a touch panel 311, a ten-key 312, a start button 313, a reset button 314, function keys 315, and an initial setting button 316. The touch panel 311 is hardware (touch operation part) for making the input by a touch operation, and is also hardware (screen display part) for obtaining the output by a screen display. The ten-key 312 is hardware for making a numerical input by a key (button) operation. The start button 313 is hardware for making a start operation by a button operation. The reset button 314 is hardware for making a reset operation by a button operation. The function key 315 is hardware for displaying an operations screen by the CSDK 146 or the JSDK 147 by a key (button) operation. The initial setting button 316 is hardware for displaying an initial setting screen by a button operation.

The document set part 301 includes an Automatic Document Feeder or feeding unit (ADF) 321, a flat bed 322, and a flat bed cover 323. The paper supply part 302 is formed by 4 paper supply trays. The paper eject part 303 is formed by 1 paper eject tray. A plurality of documents to be read (hereinafter also referred to as reading documents)

can be set on the ADF 321. The reading document is set face down on the flat bed 322.

[MFP Starting Point]

Next, the MFP starting part shown in FIG. 1 is discussed.

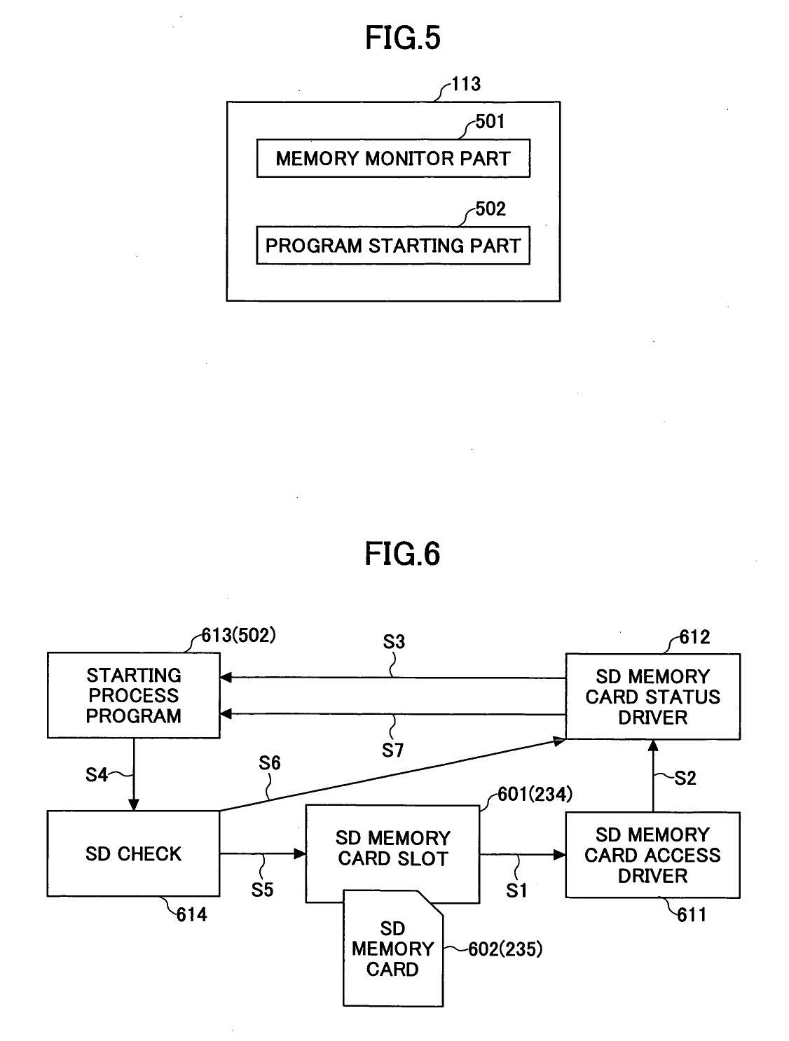

The MFP starting part 113, as shown in FIG. 5, includes a memory monitor part 501 and a program starting part 502.

As the electric power of the MFP 101 shown in FIG. 1 is turned on, BIOS forming the memory monitor part 501 and boot loader is started so that the OS such as UNIX (registered trademark) is started. And then, a program for starting the process of forming the program starting part 502 is started so that the applications 131 and the platforms 132 are properly started. In a case where UNIX (registered trademark) is started, a kernel of the UNIX (registered trademark) is started so that a root file system is developed and a file system with respect to the application 131 and the platform 132 is mounted on the root file system.

Here, examples of a mount process or starting process of the application 131 and the platforms 132 are discussed. The program starting part 502 reads a master setting file “init.conf”, etc., in the root file system so as to implement the mount process and the starting process by following a command in the master setting file. Furthermore, the program starting part 502 reads a setting file “init.conf” or “init.cnf” in the mounted file system so as to implement the mount process and the starting process by following a command in the setting file. In addition, the program starting part 502 reads a setting file “***.conf” or “***.cnf” of a setting directly “init.d” in the mounted file system so as to implement the mount process and the starting process by following a command in the setting file of the setting directly. A certification file “***.lic” where an electronic signature of the setting file is written may be prepared so that the electronic signature of the setting file may be checked before the program starting part 502 implements the mount process or the starting process by following the command in the setting file.

[Memory Card]

Next, the memory card slot 234 and the memory card 235 shown in FIG. 2 are discussed.

The memory card slot 234 is a slot for setting (inserting) the memory card 235 where a program such as the application 131 or the platform 132 is stored.

In the memory card 235, the program such as the application 131 or the platform 132 is stored for every module as a mod file “***.mod” wherein the extension is mod, and an electronic signature of the mod file is stored for every module as a mac file “***.mac” wherein the extension is mac.

In the memory card 235, the setting file (see a column of the MFP starting part) is stored as a cnf file “***.cnf” wherein the extension is cnf, and a certification file (see a column of the MFP starting part) where an electronic signature of the setting file is written is stored as a lic file “***.lic” wherein the extension is lic.

Here, the electronic signature of each file is made by using a secret key and encoding a message digest generated from the file by using a Hash function such as MD5 or SHA1. For example, an electronic signature of the mod file or cnf file is made by using the secret key and encoding the message digests generated from the mod file or cnf file.

An electronic signature check of each file can be implemented by comparing a message digest generated from the file by using a Hash function such as MD5 or SHA1 and the message digest made by decoding the electronic signature of the file by using an open key. For example, an electronic signature check of the mod file and cnf file can be implemented by comparing a message digest generated from the mod file or the cnf file and the message digest made by decoding the electronic signature written in the mac file or lic file by using an open key. The electronic signature check of each file is implemented by the program starting part 502 as a part of the mount process or starting process.

In a case where the SD memory card is applied as the memory card 235, the electronic signature of the cnf file may be made by decoding a message digest from the cnf file and SD serial ID by the secret key. Since each SD serial ID of the SD memory card is ID (identification information) peculiar to each SD memory card, the lic file stored in each SD memory card is a file peculiar to each SD memory card. Hence, duplication of the SD memory card can be prevented. In this case, an electronic signature check of the cnf file can be implemented by comparing a message digest generated from the cnf file and the SD serial ID and the message digest made by decoding the electronic signature written in the lic file by using an open key. The SD serial ID of each SD memory card is stored in the corresponding SD memory card.

As the memory card 235, a SD (Secure Digital) memory card that is a kind of a flash memory card, is used. By using the SD memory card, for example, a large amount of memory can be used at low cost. As the memory card slot 234, an SD memory card slot can be used.

The MFP 101 shown in FIG. 1, as shown in FIG. 6, includes an SD memory card access driver (SDaccess) 611, an SD memory card status driver (SDstatus) 612, a starting process program 613, and an SD memory card check program (SDcheck) 614 as software with respect to an SD memory card slot 601 and an SD memory card 602 which correspond to the memory card slot 234 and memory card 235, respectively.

The SDaccess 611 is a driver for implementing access control against the SD memory card 602 such as detection of installing or taking out of the SD memory card 602. The SDstatus 612 is a driver for managing information with respect to the installation, taking out, mounting, or unmounting of the SD memory card 602. The starting process program 613 is a program forming the program starting part 502 shown in FIG. 5. The SDcheck 614 is a program for implementing mounting or unmounting of the Sd memory card 602.

In a case where the SD memory card 602 is inserted in the SM memory card slot 601, the SDaccess 611 detects in advance that the SD memory card 602 is inserted (S1) and notifies the SDstatus 612 about this (S2). Corresponding to this, the SDstatus 612 manages information that the SD memory card 602 is inserted and so notifies the starting process program 613 (S3). Corresponding to this, the starting process program 613 starts the SDcheck 614 in order to implement mount of the SD memory card 602 (S4). Corresponding to this, the SDcheck 614 implements the mounting of the SD memory card 602 and notifies the SDstatus 612 about this (S6). Corresponding to this, the SDstatus 612 manages information that the SD memory card 602 is mounted and so notifies the starting process program 613 (S7).

In a case where the SD memory card 602 is taken out from the SD memory card slot 601, the SDaccess 611 detects what the SD memory card 602 is taken out (S1) and notifies the SDstatus 612 about this (S2). Corresponding to this, the SDstatus 612 manages information that the SD memory card 602 is taken out and so notifies the starting process program 613 (S3). Corresponding to this, the starting process program 613 starts the SDcheck 614 in order to implement unmounting of the SD memory card 602 (S4). Corresponding to this, the SDcheck 614 implements unmounting of the SD memory card 602 and notifies the SDstatus 612 about this (S6). Corresponding to this, the SDstatus 612 manages information that the SD memory card 602 is unmounted and so notifies the starting process program 613 (S7).

So called hot swap can be implemented by using the SD memory card. In other words, an operation for inserting the SD memory card 602 in the SD memory card slot 601 and operation for taking out the SD memory card 602 from the SD memory card slot 601 can be done after the MFP 101 is started.

[JSDK]

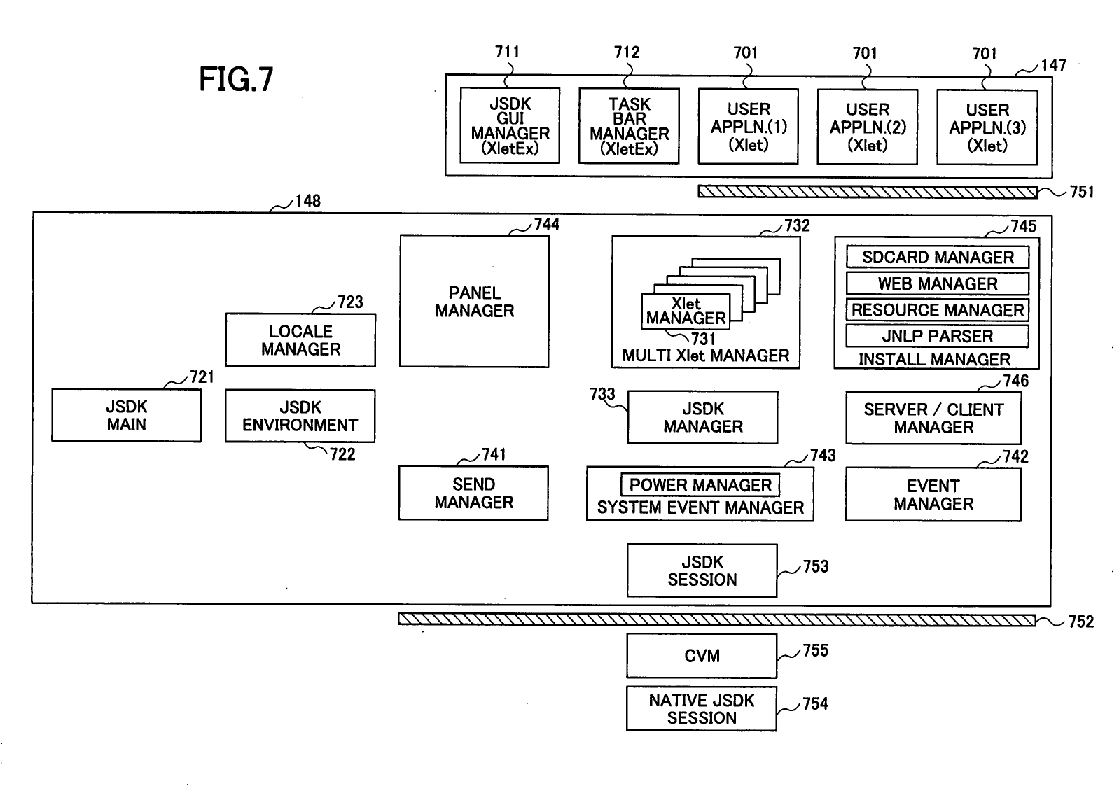

FIG. 7 is a class view of the JSDK platform 148 and the JSDK application 147 of FIG. 1. The JSDK platform 148 and the JSDK application 147 are implemented as the same process, as a single process as a whole. Each block in the JSDK platform 148 and the JSDK application 147 is implemented in parallel in a thread unit, as a thread on this single process (multi-thread). The JSDK application 147 and the JSDK platform 148 are translated in a lump from source code to byte code by a Java (registered trademark) complier and implemented (interpreted) by a Java (registered trademark) virtual machine line by line. The JSDK application 147 and the JSDK platform 148 are based on Personal Basis Profile of Java (registered trademark) 2 Micro Edition.

As the JSDK application 147, a user application 701, JSDK GUI Manager 711, Task Bar Manager 712, or the like can be used.

The user application 701 is a JSDK application developed by using JSDK by a user or vender of the MFP 101. The JSDK GUI Manager 711 is a JSDK application for displaying an operations screen whose operation object is another JSDK application (user application 701). The Task Bar Manager 712 is a JSDK application for displaying a task bar whose operation object is another JSDK application (user application 701).

Here, the user application 701 is Xlet which is, as well as a standalone application or applet, a Java (registered trademark) application. The JSDK GUI Manager 711 and the Task Bar Manager 712 are Xlet (XletEx) where the original extension is provided.

Classes, namely, JSDK Main 721, JSDK Environment 722, Locale manager 723, Xlet Managers 731, Multi Xlet Manager 732, JSDK Manager 733, Send Manager 741, Event Manager 742, System Event Manager 743, Panel Manager 744, Install Manager 745, Server/Client Manager 746, and others are provided in the JSDK platform 148.

The JSDK Main 721 is a class for starting the JDK system. The locale Manager 723 is a class corresponding to international, namely designating a language.

The Xlet Managers 731 is a class managing the life cycles of the Xlet one by one. Here, life cycles of five Xlets are managed one-by-one by five Xlet Managers 731. The Multi Xlet Manager 732 manages life cycles of all of the Xlet Managers 731. Here, all of the life cycles of five Xlet Managers 731 are managed by a single Multi Xlet Manager 732. The JSDK Manager 733 is a class for managing the life cycles of the entire JSDK system. For example, life cycles of the Multi Xlet Manager 732, the Send Manager 741, the Event Manager 742, the System Event Manager 743, the Panel Manager 744, the Install Manager 745, and the Server/Client Manager 746 are managed by the JSDL Manager 733.

The System Event Manager 743 is a class managing a system event such as an electric power mode from the platform 132 shown in FIG. 1. The Panel Manager 744 is a class for mediating at the time when a single Xlet provides an image on the display part of the operations panel 202. The Install Manager 745 is a class for managing the install or uninstall from the SDcard or the Web.

In the JSDK system shown in FIG. 7, a JSDK API 751 and JSDK API 752 are provided as APIs. It is a difference between Xlet and XletEx that for Xlet JSDL API 751 can be used and the JSDK platform 148 can be accessed for accessing the object. In the MFP 101, as an element of the JSDK system shown in FIG. 7, Native JSDK Session 754 and JSDK Session 753 that comprises an interface of C language and Java (registered trademark) language are provided. The MFP 101 shown in FIG. 1 further includes, as an element of the JSDK system shown in FIG. 7, a CVM (compact virtual machine) 755 that is a Java (registered trademark) virtual machine for implementing, line by line, the Java (registered trademark) program translated by the Java (registered trademark) complier from source code to the byte code.

[SAS]

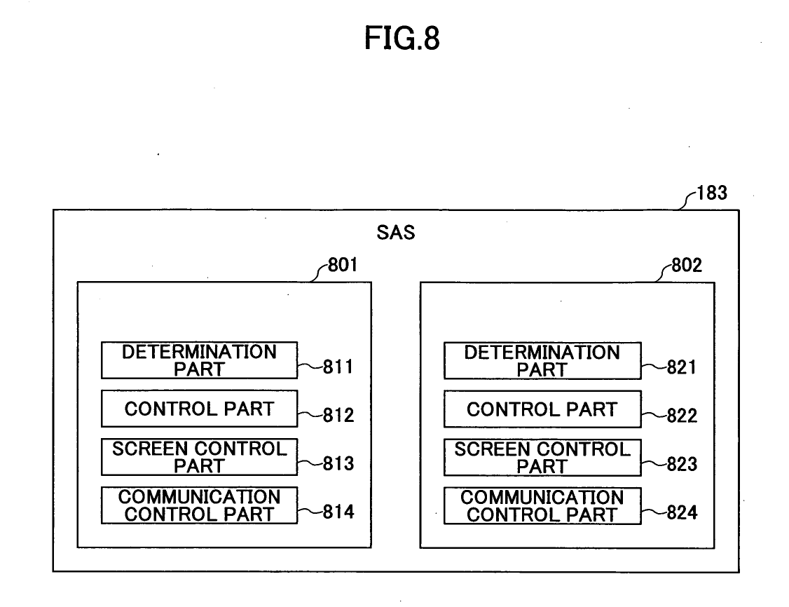

FIG. 8 is a functional block view of an SAS 183 of FIG. 1. The SAS 183 shown in FIG. 1 includes functional blocks such as an install part 801 and an update part 802. The install part 801 is a functional block for obtaining the CVM from the SD memory card set in the MFP 101 or the Web server connected to the MFP 101 so as to install the CVM in the MFP 101. The update part 802 is a functional block for obtaining the CVM from the SD memory card set in the MFP 101 or the Web server connected to the MFP 101 and updating the CVM 755 (See FIG. 7) of the MFP 101. The install part 801 includes an install determining part 811, an install control part 812, a picture control part 813, a communication control part 814, and others. The update part 802 includes an update control part 821, an update control part 822, a picture control part 823, a communication control part 824, and others.

In FIG. 8, the install part 801 and the update part 802 are clearly distinguished. Furthermore, in the following description, the install process and the update process are distinguished. However, the update is not excluded from the concept of the install. The update may be an example of the install.

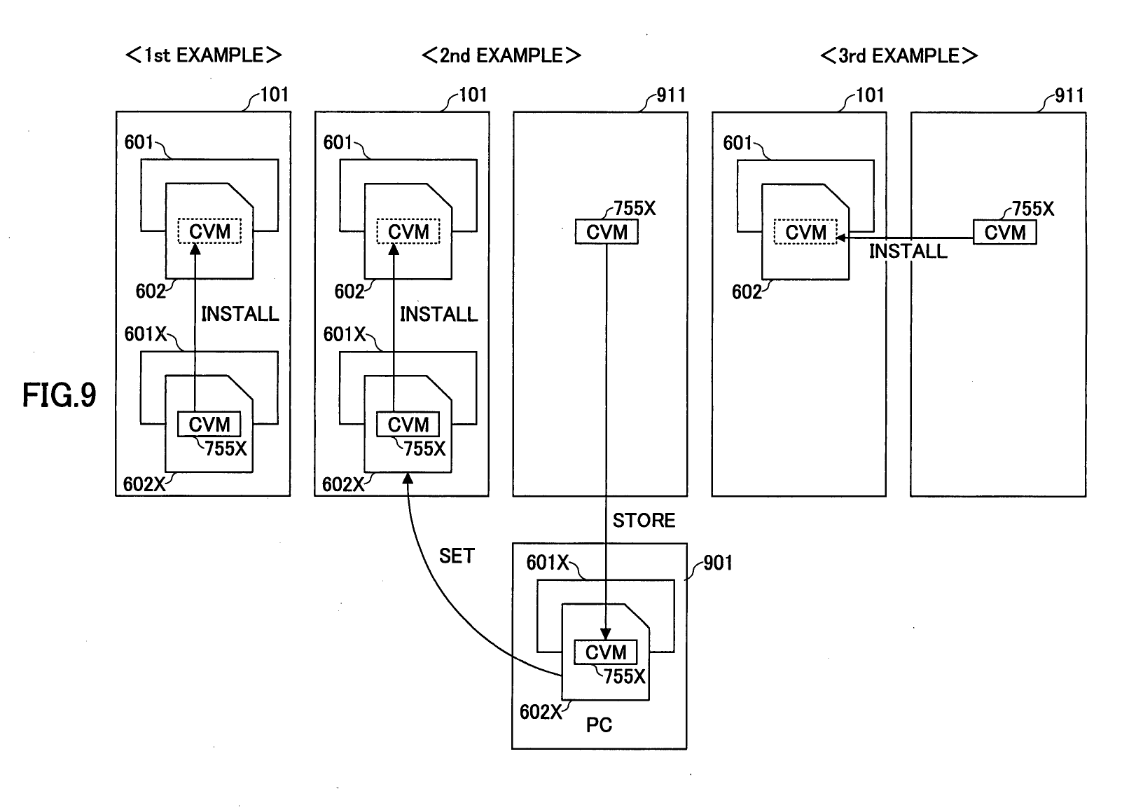

FIG. 9 is a block diagram for explaining an install process implemented by the SAS 183.

In a first example, an operator of the MFP 101 sets an SD memory card 602X in an SD memory card slot 601 of the MFP 101. The install part 801 of the SAS 183 obtains the CVM from the SD memory card 602X set in the SD memory card slot 601X of the MFP 101 and installs the CVM in the SD memory card 602 set in the SD memory card slot 601 of the MFP 101.

In a second example, an operator of the PC 901 makes a PC 901 network connection to the Web server 911. The Web browser of the PC 901 obtains the CVM 755X and stores the CVM in the SD memory card 602X set in the SD memory card slot 601X of the PC 901. Next, the operator of MFP 101 sets the SD memory card 602X in the SD memory card slot 601X of the MFP 101. The install part 801 of the SAS 183 obtains the CVM from the SD memory card 602X set in the SD memory card slot 601X of the MFP 101 and installs the CVM in the SD memory card 602 set in the SD memory card slot 601 of the MFP 101.

In a third example, the operator of the MFP 101 makes a MFP 101 network connection to the Web server 911. The install part 801 of the SAS 183 obtains the CVM from the Web server 911 network-connected to the MFP 101 and installs the CVM in the SD memory card 602 set in the SD memory card slot 601 of the MFP 101.

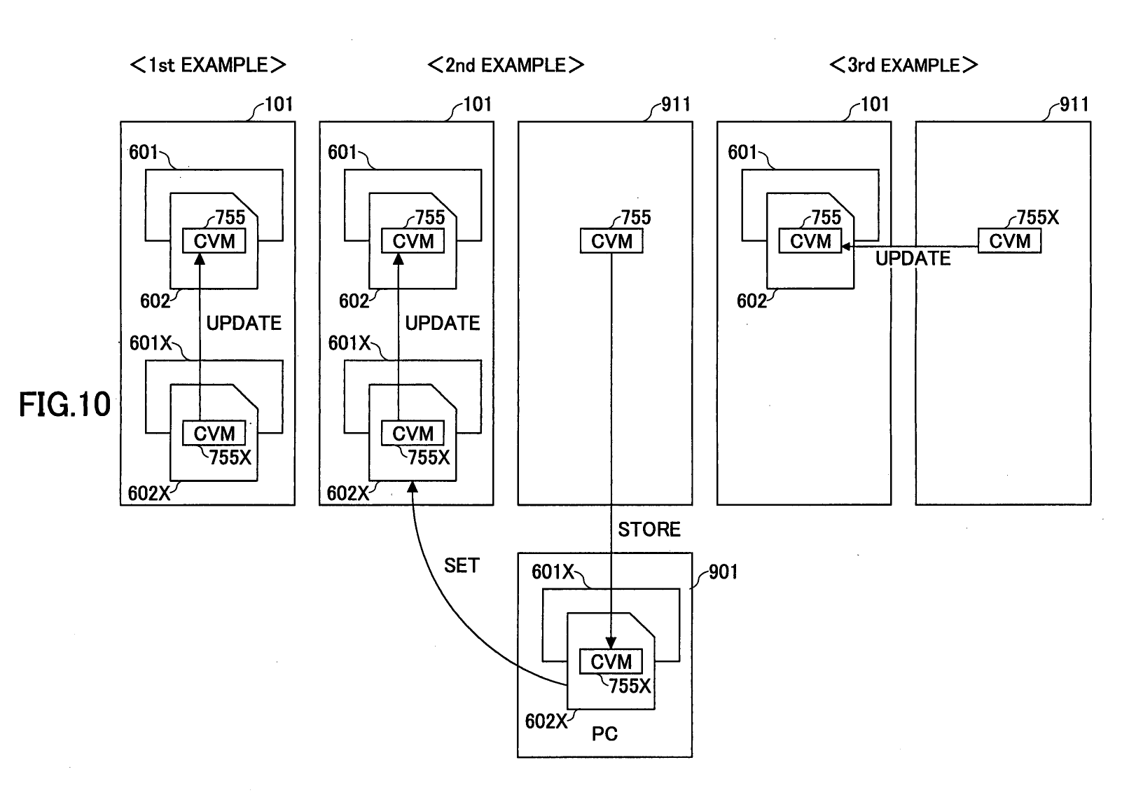

FIG. 10 is a block diagram for explaining an update process implemented by the SAS 183.

In the first example, the operator of the MFP 101 sets an SD memory card 602X in an SD memory card slot 601X of the MFP 101. The update part 802 of the SAS 183 obtains the CVM from the SD memory card 602X set in the SD memory card slot 601X of the MFP 101 and updates the CVM 755 of the SD memory card 602 set in the SD memory card slot 601 of the MFP 101 by the CVM 755X.

In the second example, the operator of the PC 901 network-connects the PC 901 to the Web server 911. The Web browser of the PC 901 obtains the CVM from the Web server 911 network-connected to the PC 901 and stores the CVM in the SD memory card 602X set in the SD memory card slot 601X of the PC 901. Next, the operator of MFP 101 sets the SD memory card 602X in the SD memory card slot 601X of the MFP 101. The update part 802 of the SAS 183 obtains the CVM 755X from the SD memory card 602X set in the SD memory card slot 601X of the MFP 101 and updates the CVM 755 of the SD memory card 602 set in the SD memory card slot 601 of the MFP 101 by the CVM 755X.

In the third example, the operator of the MFP 101 network-connects the MFP 101 to the Web server 911. The update part 802 of the SAS 183 obtains the CVM 755X from the Web server 911 network-connected to the MFP 101 and updates the CVM 755 of the SD memory card 602 set in the SD memory card slot 601 of the MFP 101 by the CVM 755X.

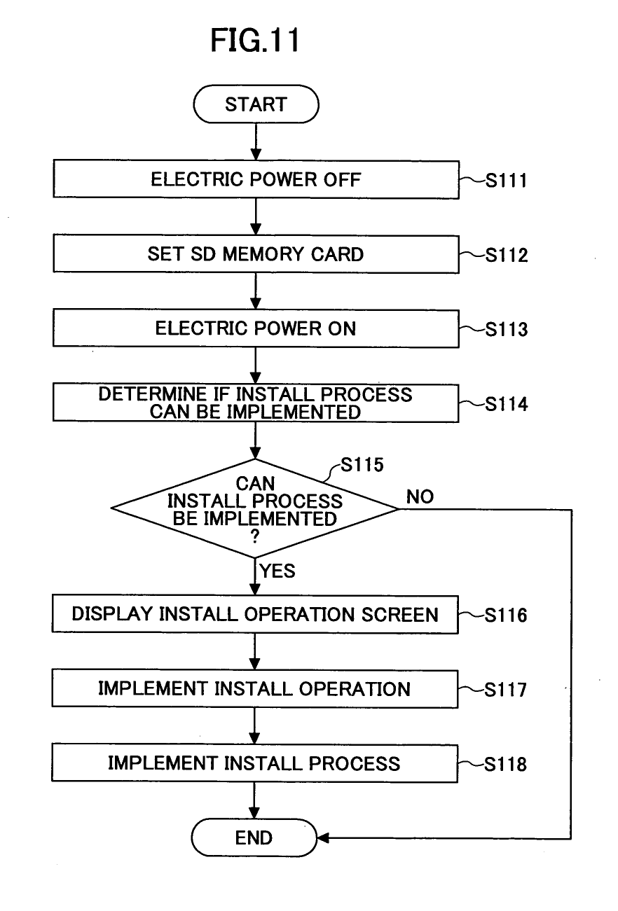

FIG. 11 is a flowchart of the first example of the install process implemented by the SAS 183.

The operator of the MFP 101 turns off the electric power of the MFP 101 (S111) and sets the SD memory card 602X in the SD memory card slot 601X of the MFP 101 (S112). And then, the operator of the MFP 101 turns on the electric power of the MFP 101 so that the install determination part 811 of the SAS 183 determines whether the install process can be implemented (S114). If the install determination part 811 of the SAS 183 determines that the install process can be implemented (S115), the picture control part 813 of the SAS 183 displays an install operations screen on the display part of the operations panel 202 (S116). Next, the operator of the MFP 101 implements the install operation on the install operations screen displayed on the display part of the operations panel 202 (S117) so that the install control part 812 of the SAS 183 implements the install process (S118). That is, the install part 801 of the SAS 183 obtains the CVM 755X from the SD memory card 602X set in the SD memory card slot 601X of the MFP 101 and installs the CVM 755X in the SD memory card 602 set in the SD memory card slot 601 of the MFP 101.

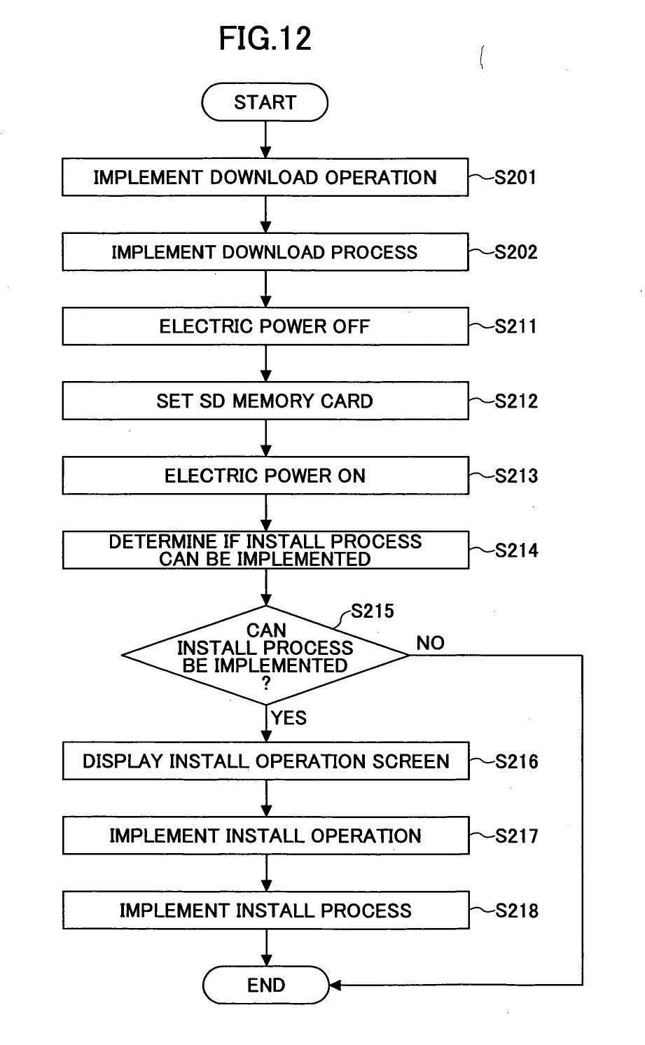

FIG. 12 is a flowchart of the second example of the install process implemented by the SAS 183.

The operator of the PC 901 implements the download operation on the download operations screen displayed on the display part of the PC 901 (S201) so that the Web browser of the PC 901 implements the download operation (S202). That is, the Web browser of the PC 901 obtains the CVM 755X from the Web server 911 network-connected to the PC 901 and stores the CVM 755X in the SD memory card 602X set in the SD memory card slot 601X of the PC 901.

The operator of the MFP 101 turns off the electric power of the MFP 101 (S211) and sets the SD memory card 602X in the SD memory card slot 601X of the MFP 101 (S212). And then, the operator of the MFP 101 turns on the electric power of the MFP 101 (S213) so that the install determination part 811 of the SAS 183 determines whether the install process can be implemented (S214). If the install determination part 811 of the SAS 183 determines that the install process can be implemented (S215), the picture control part 813 of the SAS 183 displays an install operations screen on the display part of the operations panel 202 (S216). Next, the operator of the MFP 101 implements the install operation on the install operations screen displayed on the display part of the operations panel 202 (S217) so that the install control part 812 of the SAS 183 implements the install process (S218). That is, the install part 801 of the SAS 183 obtains the CVM 755X from the SD memory card 602X set in the SD memory card slot 601X of the MFP 101 and installs the CVM 755X in the SD memory card 602 set in the SD memory card slot 601 of the MFP 101.

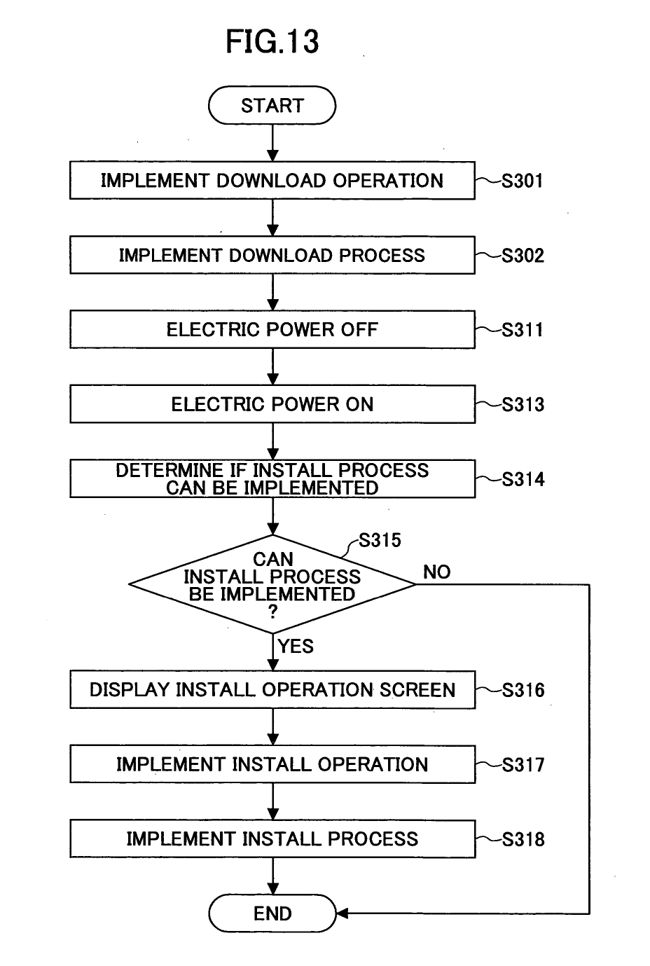

FIG. 13 is a flowchart of a third example of the install process implemented by the SAS 183.

The operator of the MFP 101 implements the download operation on the download operations screen displayed on the display part of the operations panel 202 (S301) so that the communication control part 814 of the SAS 183 implements the download operation (S302). That is, the CVM 755X is obtained from the Web server 911 network-connected to the MFP 101 and stored in a temporary storage area of the MFP 101.

The operator of the MFP 101 turns off the electric power of the MFP 101 (S311) and turns on the electric power of the MFP 101 (S313) so that the install determination part 811 of the SAS 183 determines whether the install process can be implemented (S314). If the install determination part 811 of the SAS 183 determines that the install process can be implemented (S315), the picture control part 813 of the SAS 183 displays an install operations screen on the display part of the operations panel 202 (S316). Next, the operator of the MFP 101 implements the install operation on the install operations screen displayed on the display part of the operations panel 202 (S317) so that the install control part 812 of the SAS 183 implements the install process (S318). That is, the install part 801 of the SAS 183 obtains the CVM 755X stored in the temporary storage are of the MFP 101 and installs the CVM 755X in the SD memory card 602 set in the SD memory card slot 601 of the MFP 101.

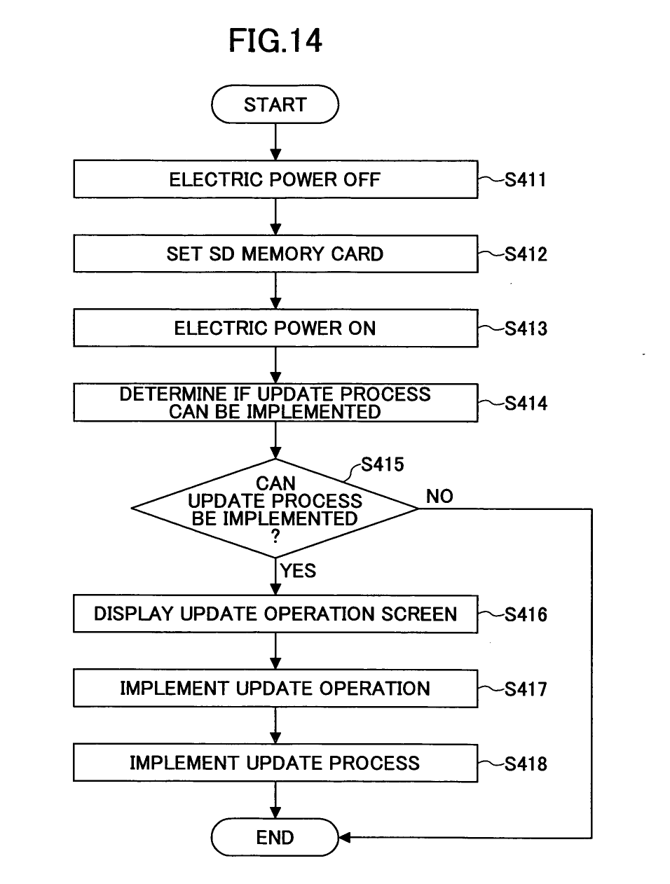

FIG. 14 is a flowchart of a first example of the update process implemented by the SAS 183.

The operator of the MFP 101 turns off the electric power of the MFP 101 (S411) and sets the SD memory card 602X in the SD memory card slot 601X of the MFP 101 (S412). And then, the operator of the MFP 101 turns on the electric power of the MFP 101 (S413) so that the update determination part 821 of the SAS 183 determines whether the update process can be implemented (S414). If the update determination part 821 of the SAS 183 determines that the update process can be implemented (S415), the picture control part 823 of the SAS 183 displays an update operations screen on the display part of the operations panel 202 (S416). Next, the operator of the MFP 101 implements the update operation on the update operations screen displayed on the display part of the operations panel 202 (S417) so that the update control part 822 of the SAS 183 implements the update process (S418). That is, the update part 801 of the SAS 183 obtains the CVM 755X from the SD memory card 602X set in the SD memory card slot 601X of the MFP 101 and updates the CVM 755X in the SD memory card 602 set in the SD memory card slot 601 of the MFP 101.

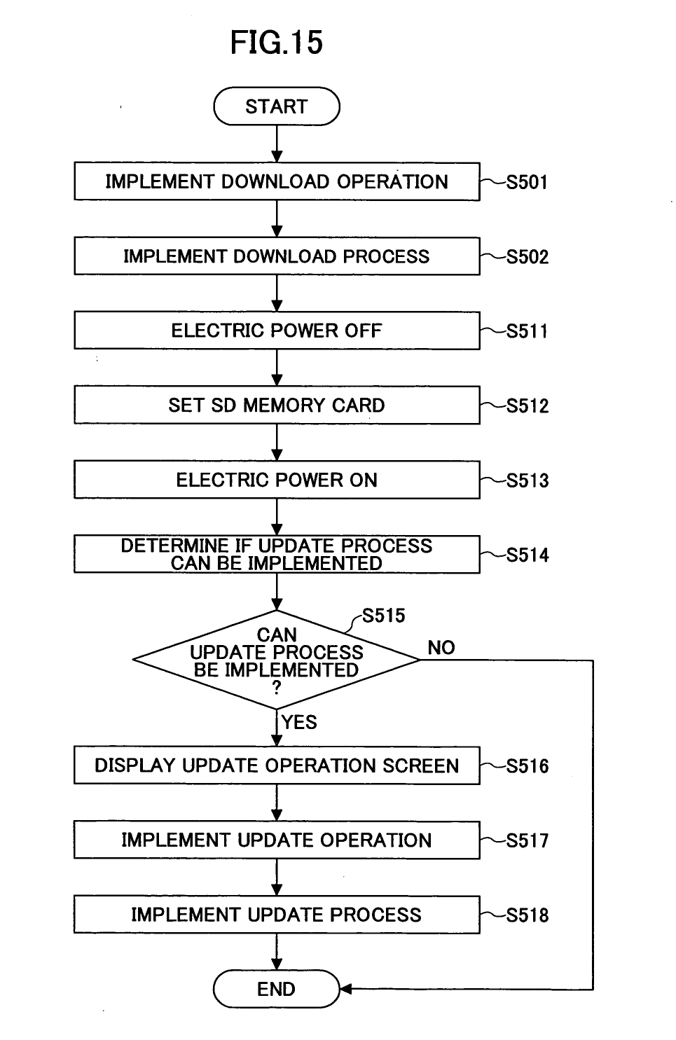

FIG. 15 is a flowchart of a second example of the update process implemented by the SAS 183.

The operator of the PC 901 implements the download operation on the download operations screen displayed on the display part of the PC 901 (S501) so that the Web browser of the PC 901 implements the download operation (S502). That is, the Web browser of the PC 901 obtains the CVM 755X from the Web server 911 network-connected to the PC 901 and stores the CVM 755X in the SD memory card 602X set in the SD memory card slot 601X of the PC 901.

The operator of the MFP 101 turns off the electric power of the MFP 101 (S511) and sets the SD memory card 602X in the SD memory card slot 601X of the MFP 101 (S512). And then, the operator of the MFP 101 turns on the electric power of the MFP 101 (S513) so that the update determination part 821 of the SAS 183 determines whether the update process can be implemented (S514). If the update determination part 821 of the SAS 183 determines that the update process can be implemented (S515), the picture control part 823 of the SAS 183 displays an update operations screen on the display part of the operations panel 202 (S516). Next, the operator of the MFP 101 implements the update operation on the update operation screen displayed on the display part of the operations panel 202 (S517) so that the update control part 822 of the SAS 183 implements the update process (S518). That is, the update part 801 of the SAS 183 obtains the CVM 755X from the SD memory card 602X set in the SD memory card slot 601X of the MFP 101 and updates the CVM 755 in the SD memory card 602 set in the SD memory card slot 601 of the MFP 101 by the CVM 755X

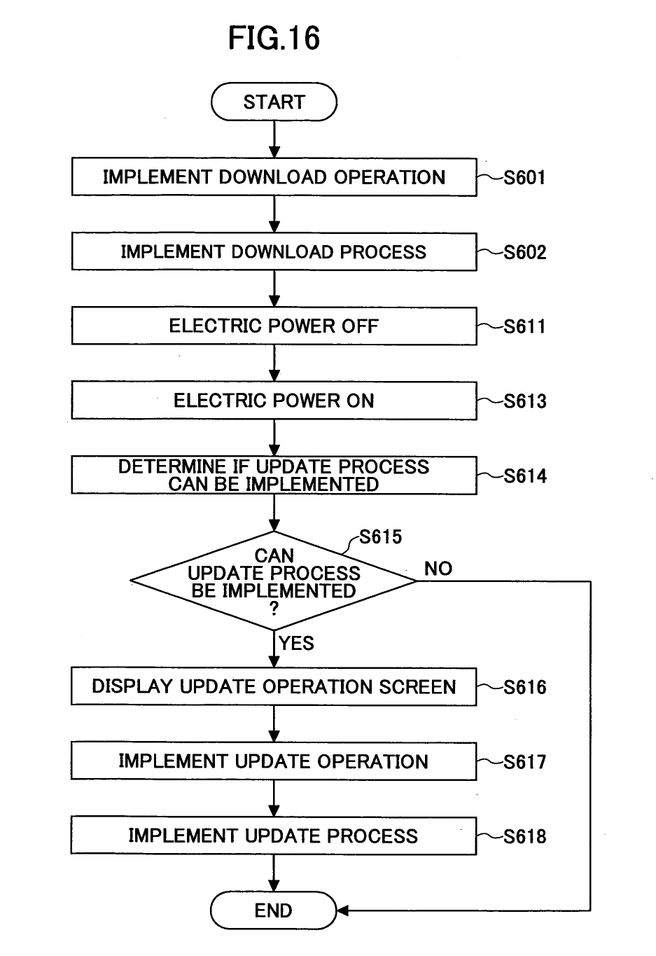

FIG. 16 is a flowchart of a third example of the update process implemented by the SAS 183.

The operator of the MFP 101 implements the download operation on the download operations screen displayed on the display part of the operations panel 202 (S601) so that the communication control part 824 of the SAS 183 implements the download operation (S602). That is, the CVM 755X is obtained from the Web server 911 network-connected to the MFP 101 and stored in a temporary storage area of the MFP 101.

The operator of the MFP 101 turns off the electric power of the MFP 101 (S611) and turns on the electric power of the MFP 101 (S613) so that the update determination part 821 of the SAS 183 determines whether the update process can be implemented (S614). If the update determination part 821 of the SAS 183 determines that the update process can be implemented (S315), the picture control part 823 of the SAS 183 displays an update operations screen on the display part of the operations panel 202 (S616). Next, the operator of the MFP 101 implements the update operation on the update operations screen displayed on the display part of the operations panel 202 (S617) so that the update control part 822 of the SAS 183 implements the update process (S618). That is, the update part 801 of the SAS 183 obtains the CVM 755X stored in the temporary storage area of the MFP 101 and updates the CVM 755X of the SD memory card 602 set in the SD memory card slot 601 of the MFP 101 by the CVM 755X.

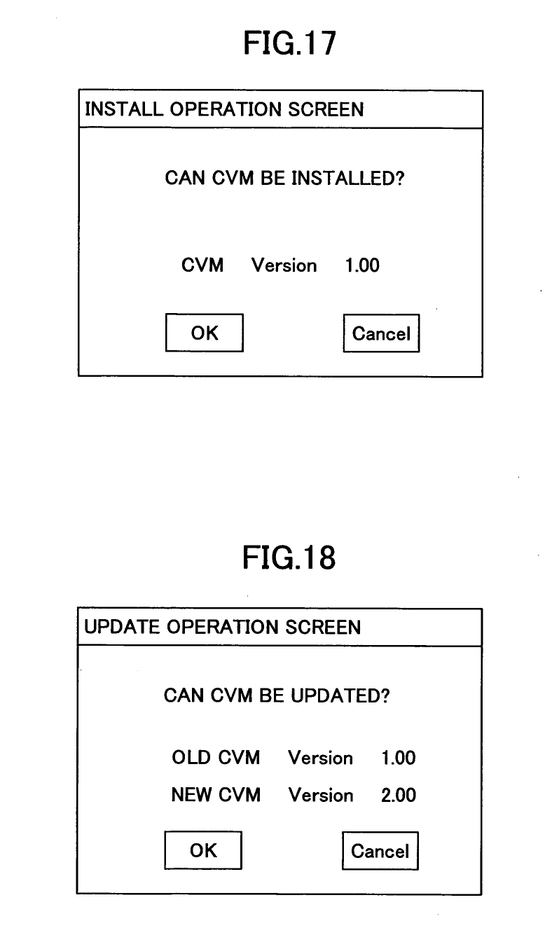

FIG. 17 is a view of an install operations screen displayed by the SAS 183. The install operations screen includes an “OK” button for the install operation whereby the install process is implemented and a “Cancel” button for the install stopping operation whereby the install process is stopped.

FIG. 18 is a view of an update operations screen displayed by the SAS 183. The update operations screen includes an “OK” button for the update operation whereby the update process is implemented and a “Cancel” button for the update stopping operation whereby the update process is stopped.

Thus, in the MFP 101 shown in FIG. 1, the CVM can be provided in the MFP 101 by installing the CVM in the MFP 101 or updating the CVM of the MFP 101. Because of this, it is possible to provide the CVM to the MFP 101, even if the CVM is newly developed, a problem of the CVM is solved, or the CVM is made for corresponding to new kind of MFP 101 after the MFP 101 is marketed.

Next, machine dependency of the CVM is discussed.

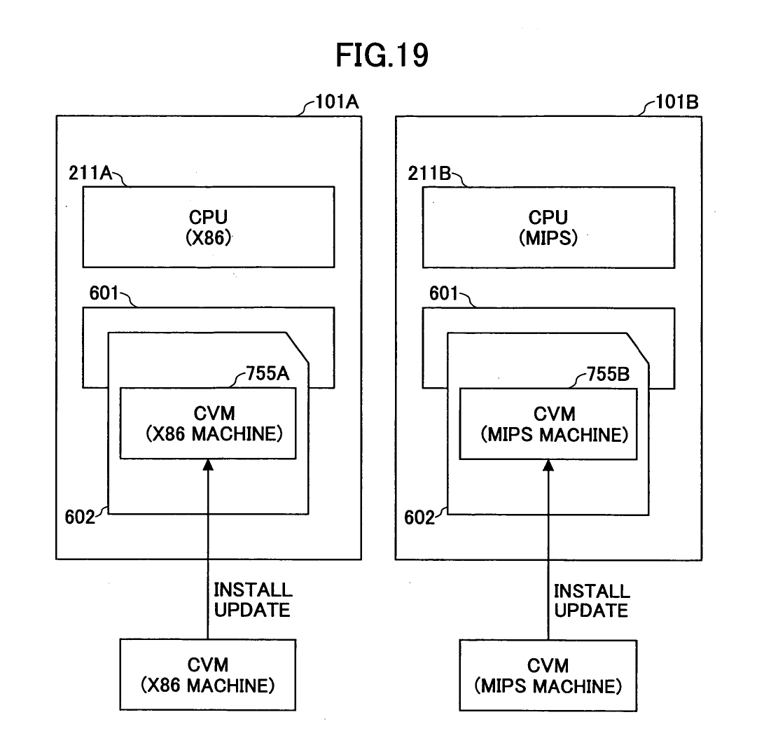

FIG. 19 is a block diagram for explaining machine dependency of CVM of the MFP 101 shown in FIG. 1. There are two kinds of CPU 211 of the image forming apparatus such as the MFP 101, namely X86 and MIPS. The X86 is used for high speed processing at high cost, that is, used for a machine having output equal to or greater than 60 ppm. The MIPS is used for low speed processing at low cost, that is, used for a machine having output less than 60 ppm. In FIG. 19, the CPU 211A of the MFP 101A corresponds to X86 and the CPU 211B of the MFP 101B corresponds to MIPS.

The CVM 755 which can be used for the image forming apparatus such as the MFP 101 depends on the kind of the CPU 211 of the image forming apparatus such as the MFP 101. Because of this, there are two kinds of the CVM 755 which can be used for the image forming apparatus such as the MFP 101, namely a CVM for a machine having X86 and a CVM for a machine having MIPS. This is a machine dependency of the CVM 755 of the image forming apparatus such as the MFP 101. In an example shown in FIG. 19, a CVM 755A of the MFP 101A having X86 is the CVM for the machine having X86, and a CVM 755B of the MFP 101M having MIPS is the CVM for the machine having MIPS.

In the install process implemented by the SAS 183, the install part 801 of the SAS 183 installs a single kind of the two kinds of CVMs which can be used in the MFP 101 and are different depending on the kind of CPU 211 of the MFP 101, in the MFP 101. In the example shown in FIG. 19, the CVM for the machine having X86 is installed in the MFP 101A which is a machine having X86, and the CVM for the machine having MIPS is installed in the MFP 101B which is a machine having MIPS. S118 shown in FIG. 11, S218 shown in FIG. 12, and S318 shown in FIG. 13 correspond to this.

In the update process implemented by the SAS 183, the update part 802 of the SAS 183 updates a single kind of two kinds of CVMs which can be used in the MFP 101 and are different depending on the kind of CPU 211 of the MFP 101. In the example shown in FIG. 19, the CVM 755A for the machine having X86 is updated in the MFP 101A which is a machine having X86, and the CVM 755B for the machine having MIPS is updated in the MFP 101B which is a machine having MIPS. S418 shown in FIG. 14, S518 shown in FIG. 15, and S618 shown in FIG. 16 correspond to this.

The number of kinds of the CPU 211 of the image forming apparatus such as the MFP 101 may be more than three and the number of kinds of the CVM 755 of the image forming apparatus such as the MFP 101 may be more than three. The number of kinds of the CVM 755 of the image forming apparatus such as the MFP 101 may be varied depending on a kind of library such as API 133 of the image forming apparatus such as the MFP 101.

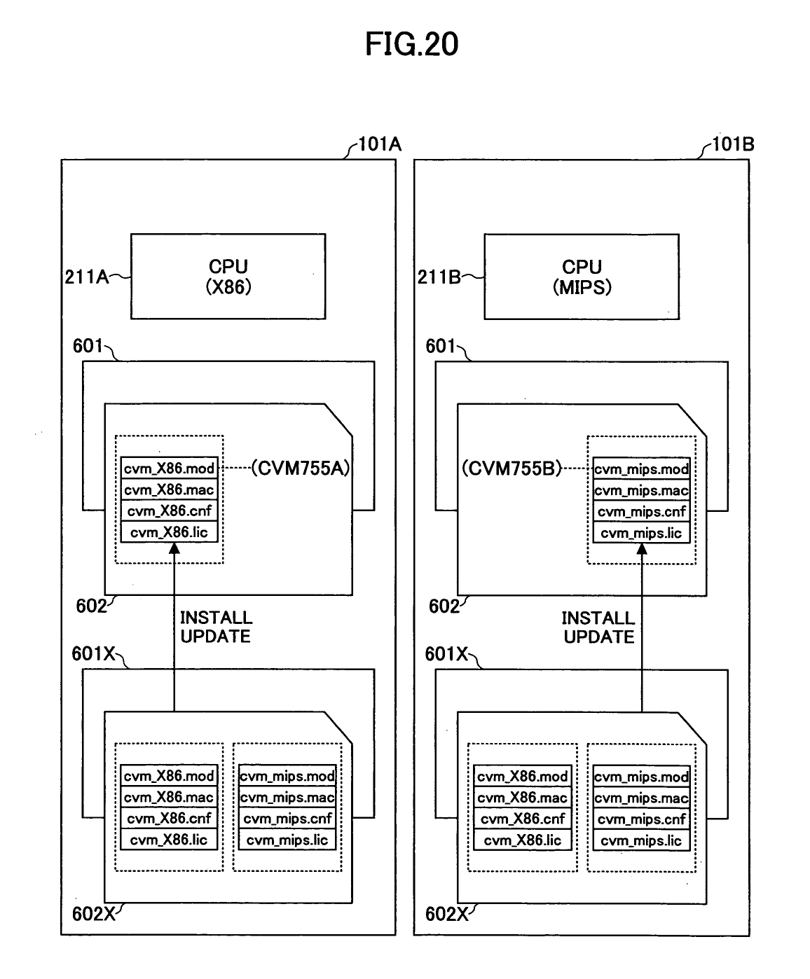

FIG. 20 is a block diagram for explaining a file of the CVM 755 of the MFP 101 shown in FIG. 1. “cvm_x86.mod”, “cvm_x86.mac”, “cvm_x86.cnf”, and “cvm_x86.lic” are stored in the SD memory card 602 set in the SD memory card slot 601 of the MFP 101A. These files are related to CVM 755A. The CVM 755A is stored in “cvm_x86.mod”“cvm_mips.mod”, “cvm_mips.mac”, “cvm_mips.cnf”, and “cvm_mips.lic” are stored in the SD memory card 602 set in the SD memory card slot 601 of the MFP 101B. These files are related to CVM 755B. The CVM 755B is stored in “cvm_mips.mod”

A file name of the file related to the CVM 755A for the machine having X86 is made by joining CVM and X86. It is possible to identify through the file name that the file is related to the CVM for the machine having X86. A file name of the file related to the CVM 755M for the machine having MIPS is made by joining CVM and MIPS. It is possible to identify through the file name that the file is related to the CVM for the machine having MIPS. Thus, the file name of the file related to the CVM 755 is identification information for identifying the image forming apparatus such as the MFP 101 where the CVM 755 can be used.

The identification information for identifying the image forming apparatus such as the MFP 101 where the CVM 755 can be used may not always be a file name of the file related to the CVM 755. For example, the identification information may be stored in the file related to the CVM 755. In this case, however, opening the file is necessary for confirming the identification information. Therefore, it is preferable that the identification information be included in the file name from the view point of the process efficiency.

In the install process implemented by the SAS 183, “cvm_x86.mod”, “cvm_x86.mac”, “cvm_x86.cnf”, “cvm_x86.lic”, “cvm_mips.mod”, “cvm_mips.mac”, “cvm_mips.cnf”, and “cvm_mips.lic” are stored in the SD memory card 602X set in the SD memory card slot 601X of the MFP 101. That is, four files related to the CVM for the machine having X86 and four files related to the CVM for the machine having MIPS are stored. The install part 801 of the SAS 183 “automatically selects” the CVM to be installed from CVMs stored in the SD memory card 602X based on the file name of the file where the CVM is stored. The file name of the file where the CVM is stored is identification information for identifying the MFP 101 where the CVM can be used. By using the file name of the file where the CVM is stored, it is possible to “automatically select” the CVM which can be used in the MFP 101. In the example shown in FIG. 20, the CVM for the machine having X86 is automatically selected in the MFP 101A for the machine having X86. The CVM for the machine having MIPS is automatically selected in the MFP 101B for the machine having MIPS. S114 shown in FIG. 11 and S214 shown in FIG. 12 correspond to this.

In the update process implemented by the SAS 183, “cvm_x86.mod”, “cvm_x86.mac”, “cvm_x86.cnf”, “cvm_x86.lic”, “cvm_mips.mod”, “cvm_mips.mac”, “cvm_mips.cnf”, and “cvm_mips.lic” are stored in the SD memory card 602X set in the SD memory card slot 601X of the MFP 101. That is, four files related to the CVM for the machine having X86 and four files related to the CVM for the machine having MIPS are stored. The update part 802 of the SAS 183 “automatically selects” the CVM to be updated from CVMs stored in the SD memory card 602X based on the file name of the file where the CVM is stored. The file name of the file where the CVM is stored is identification information for identifying the MFP 101 where the CVM can be used. By using the file name of the file where the CVM is stored, it is possible to “automatically select” the CVM which can be used in the MFP 101. In the example shown in FIG. 20, the CVM for the machine having X86 is automatically selected in the MFP 101A for the machine having X86. The CVM for the machine having MIPS is automatically selected in the MFP 101B for the machine having MIPS. S414 shown in FIG. 14 and S514 shown in FIG. 15 correspond to this.

Thus, in the MFP 101 shown in FIG. 1, based on the file name of the file where the CVM is stored, the CVM to be installed or updated which is stored in the SD memory card 602X is automatically selected. As a result of this, it is possible to provide two or more kinds of CVMs by a single kind of the SD memory card 602X In the SD memory card 602X for updating, the cnf file and lic file may not be stored but the mod file and mac file may be stored by being joined with each other, such as in a form of the fwu file.

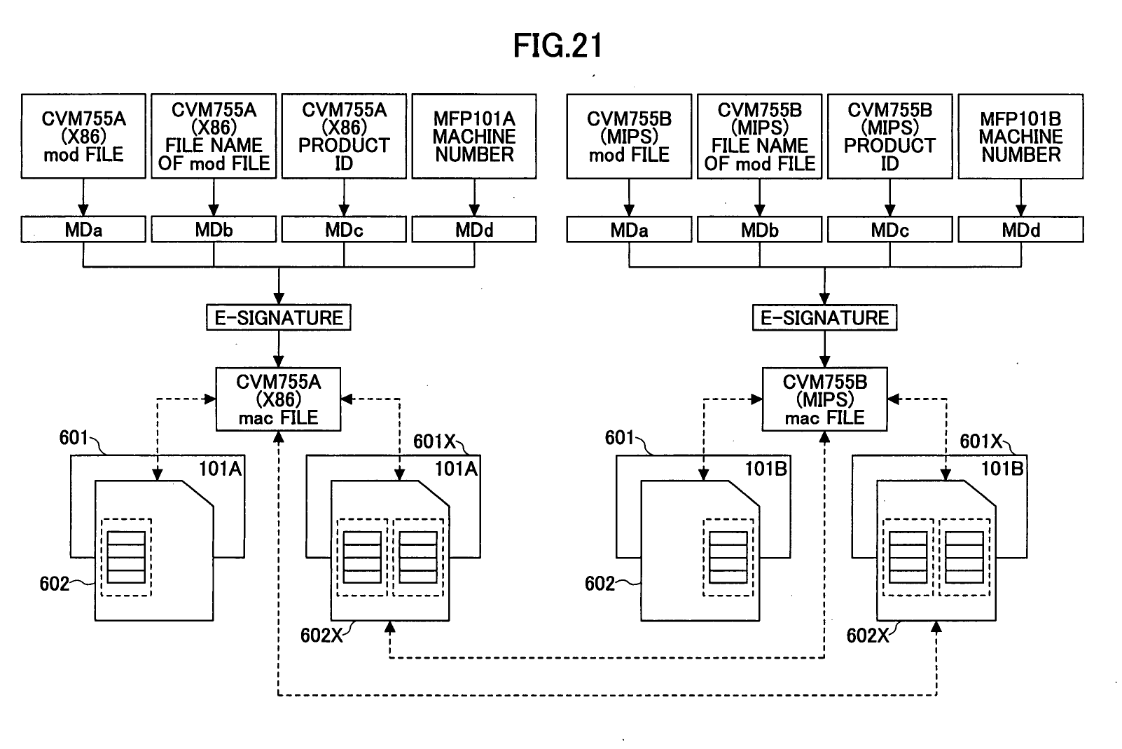

FIG. 21 is a block diagram for explaining mod and mac files of the CVM 755 of the MFP 101 shown in FIG. 1. In the memory card 602 set in the SD memory card slot 601 of the MFP 101A, the “electronic signature” generated by mixing the message digest MDa made from the mod file related to CVM 755A, the message digest MDb made from the file name “cvm_x86.mod” of the mod file related to the CVM 755A, the message digest MDc made from the product ID of the CVM 755A, and the message digest MDd made from a machine number peculiar to the machine of the MFP 101A, and encoding by the secret key, is stored in the mac file related to the CVM 755A. In the memory card 602 set in the SD memory card slot 601 of the MFP 101B, the “electronic signature” generated by mixing the message digest MDa made from the mod file related to CVM 755B, the message digest MDb made from the file name “cvm_mips.mod” of the mod file related to the CVM 755B, the message digest MDc made from the product ID of the CVM 755B, and the message digest MDd made from a machine number peculiar to the machine of the MFP 101B, and encoding by the secret key, is stored in the mac file related to the CVM 755B.

In the install process implemented by the SAS 183, in the memory card 602X set in the SD memory card slot 601X of the MFP 101, the “electronic signature” generated by mixing the message digest MDa made from the mod file related to CVM for the machine having X86, the message digest MDb made from the file name “cvm_x86.mod” of the mod file related to the CVM, the message digest MDc made from the product ID of the CVM, and the message digest MDd made from a machine number peculiar to the machine of the MFP 101, and encoding by the secret key, is stored in the mac file related to the CVM. The “electronic signature” generated by mixing the message digest MDa made from the mod file related to CVM for the machine having MIPS, the message digest MDb made from the file name “cvm_mips.mod” of the mod file related to the CVM, the message digest MDc made from the product ID of the CVM, and the message digest MDd made from a machine number peculiar to the machine of the MFP 101, and encoding by the secret key, is stored in the mac file related to the CVM.

The install part 801 of the SAS 183 “determines” whether the CVM which is automatically selected (FIG. 20) is actually installed, based on whether the “electronic signature” made from the file name of the file where the CVM is stored and stored in the SD memory card 602X is proper. Whether the CVM stored in the mod file related to the CVM for the machine having X86 is installed is determined based on whether the electronic signature stored in the mac file related to the CVM for the machine having X86 is proper. Whether the CVM stored in the mod file related to the CVM for the machine having MIPS is installed is determined based on whether the electronic signature stored in the mac file related to the CVM for the machine having MIPS is proper. S114 shown in FIG. 11 and S214 shown in FIG. 12 correspond to this.

In the update process implemented by the SAS 183, in the memory card 602X set in the SD memory card slot 601X of the MFP 101, the “electronic signature” generated by mixing the message digest MDa made from the mod file related to CVM for the machine having X86, the message digest MDb made from the file name “cvm_x86.mod” of the mod file related to the CVM, the message digest MDc made from the product ID of the CVM, and the message digest MDd made from a machine number peculiar to the machine of the MFP 101, and encoding by the secret key, is stored in the mac file related to the CVM. The “electronic signature” generated by mixing the message digest MDa made from the mod file related to CVM for the machine having MIPS, the message digest MDb made from the file name “cvm_mips.mod” of the mod file related to the CVM, the message digest MDc made from the product ID of the CVM, and the message digest MDd made from a machine number peculiar to the machine of the MFP 101, and encoding by the secret key, is stored in the mac file related to the CVM.

The update part 802 of the SAS 183 “determines” whether the CVM which is automatically selected (FIG. 20) is actually updated, based on whether the “electronic signature” made from the file name of the file where the CVM is stored and stored in the SD memory card 602X is proper. Whether the CVM stored in the mod file related to the CVM for the machine having X86 is updated is determined based on whether the electronic signature stored in the mac file related to the CVM for the machine having X86 is proper. Whether the CVM stored in the mod file related to the CVM for the machine having MIPS is updated is determined based on whether the electronic signature stored in the mac file related to the CVM for the machine having MIPS is proper. S414 shown in FIG. 14 and S514 shown in FIG. 15 correspond to this.

Thus, in the MFP 101 shown in FIG. 1, whether the CVM automatically selected is actually installed or the CVM is updated by the CVM automatically selected is determined based on whether the electronic signature made from the file name of the file where the CVM is stored and stored in the SD memory card 602X As a result of this, it is possible to prevent the file name of the file where the CVM is stored from being falsified. Confirmation of the electronic signature may be done for the entire electronic signature (confirming MDa with MDa, confirming MDb with MDb, confirming MDc with MDc, confirming MDd with MDd), the file part of the electronic signature and the file name part of the electronic signature (confirming MDa with MDa, confirming MDb with MDb), or only the file name part of the electronic signature (confirming MDa with MDa, confirming MDb with MDb).

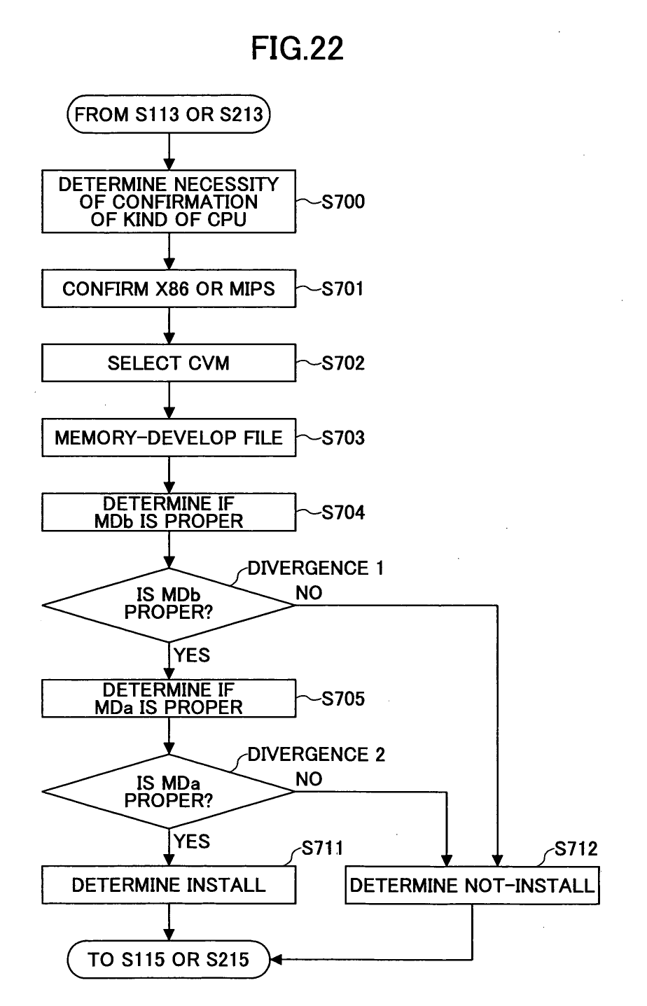

FIG. 22 is a flowchart with respect to S114 or S214 of the install process implemented by the SAS 183.

Following S113 or S213, the install determination part 811 of the SAS 183 determines whether the kind of CPU as information regarding the hardware of the MFP 101 should be determined for the installation of the program stored in the SD memory card 602X (S700). That is, in a case of the installation of the program not depending on the kind of the machine, the kind of the CPU of the MFP 101 does not matter. On the other hand, in a case of the installation of the program depending on the kind of the machine, the file being a subject of the install may be varied depending on the kind of the CPU of the MFP 101. As described above, the CVM is a program depending on the kind of the machine. Therefore, the install determination part 811 determines that the program is the CVM based on the product ID or the file name of the program stored in the SD memory card 602X so as to decide that determining of the kind of the CPU is necessary.

If the install determination part 811 of the SAS 183 determines that determining the kind of the CPU is necessary, the MFP 101 confirms whether the MFP 101 is a machine having X86 or MIPS (S701). As a method for confirming whether the MFP 101 has X86 or MIPS, for example, the determination information may be stored in the memory card 235 and the install determination part 811 may refer to the determination information. In addition, the install determination part 811 may query the CPU 211 or control service 151. Furthermore, the determination information may be hard-coded in the SAS 183 so that the confirmation may be implemented based on this.

After that, the install determination part 811 of the SAS 183 selects the CVM to be installed which is stored in the SD memory card 602X based on the file name of the file related to the CVM (S702). That is, the CVM corresponding to the MFP 101 is selected as the subject of the install by comparing the kind of the CPU confirmed at S701 and the file name of the file related to the CVM as the identification information. More specifically, in a case where the MFP 101 is a machine having X86, the CVM for the machine having X86 is selected. In a case where the MFP 101 is a machine having MIPS, the CVM for the machine having MIPS is selected.

After that, the install determination part 811 of the SAS 183 loads into memory the file related to the selected CVM (S703). And then, the install determination part 811 of the SAS 183 determines whether MDb of the electronic signature stored in the mac file related to the selected CVM is proper (S704). That is, whether the file name of the mod file related to the selected CVM is proper is determined. Whether MDb is proper can be determined by comparing MDb generated from the file name of the mod file and MDb generated by decoding the electronic signature stored in the mac file by using an open key. After that, the install determination part 811 of the SAS 183 determines whether the MDa of the electronic signature stored in the mac file related to the selected CVM is proper (S705). That is, whether the mod file related to the selected CVM is proper is determined. Whether the MDa is proper can be determined by comparing MDa generated from the mod file and MDa generated by decoding the electronic signature stored in the mac file by using an open key.

The install determination part 811 of the SAS 183 determines that the CVM is installed (S711) so as to go to S115 or S215, in a case where “MDb part” and “MDa part” of the electronic signature stored in the mac file related to the selected CVM are proper (divergences 1 and 2).

The install determination part 811 of the SAS 183 determines that the CVM is not installed (S712) so as to go to S115 or S215, in a case where “MDb part” and “MDa part” of the electronic signature stored in the mac file related to the selected CVM are not proper (divergences 1 and 2).

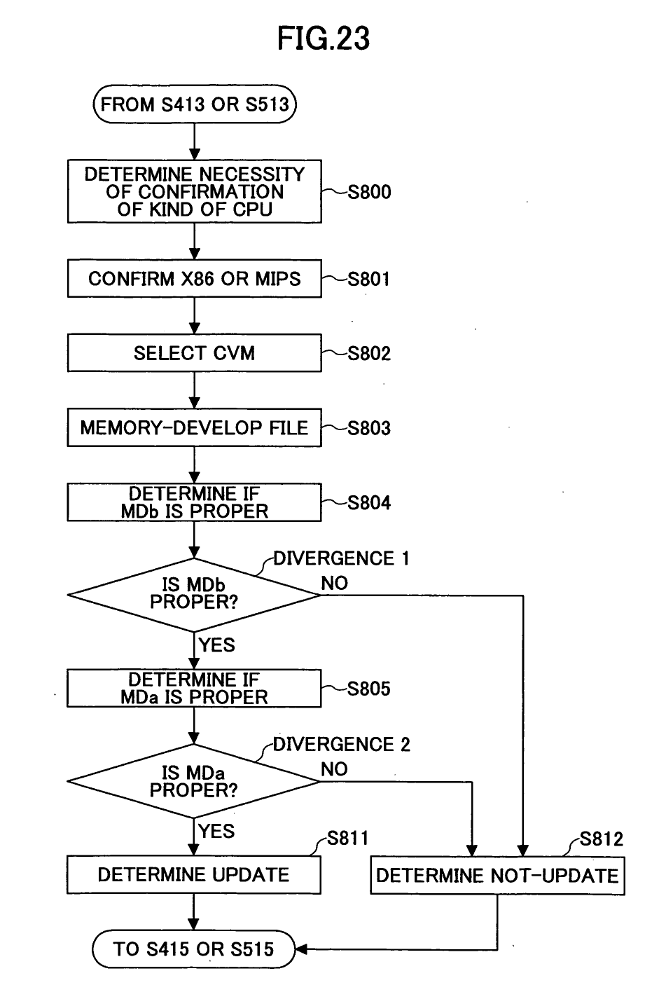

FIG. 23 is a flowchart with respect to S414 or S514 of the update process implemented by the SAS 183.

Following S413 or S513, the update determination part 821 of the SAS 183 determines whether the kind of CPU as information regarding the hardware of the MFP 101 should be determined for the update of the program stored in the SD memory card 602X (S800). That is, in a case of the update of the program not depending on the kind of the machine, the kind of the CPU of the MFP 101 does not matter. On the other hand, in a case of the update of the program depending on the kind of the machine, the file being a subject of the update may be varied depending on the kind of the CPU of the MFP 101. As described above, the CVM is a program depending on the kind of the machine. Therefore, the update determination part 821 determines that the program is the CVM based on the product ID or the file name of the program stored in the SD memory card 602X so as to decide that determination of the kind of the CPU is necessary.

If the update determination part 821 of the SAS 183 determines that the determination of the kind of the CPU is necessary, the MFP 101 confirms whether the MFP 101 is the machine having X86 or the MIPS (S801).

As a method for confirming whether the MFP 101 is the machine having X86 or the MIPS, for example, the determination information may be stored in the memory card 235 and the update determination part 821 may refer to the determination information. In addition, the update determination part 821 may query the CPU 211 or control service 151. Furthermore, the determination information may be hard-coded in the SAS 183 so that the confirmation may be implemented based on this.

After that, the update determination part 821 of the SAS 183 selects the CVM to be used for updating which is stored in the SD memory card 602X based on the file name of the file related to the CVM (S802). That is, the CVM corresponding to the MFP 101 is selected as the subject of use for updating by comparing the kind of the CPU confirmed at S801 and the file name of the file related to the CVM as the identification information. More specifically, in a case where the MFP 101 is a machine having X86, the CVM for the machine having X86 is selected. In a case where the MFP 101 is a machine having MIPS, the CVM for the machine having MIPS is selected.

After that, the update determination part 821 of the SAS 183 loads into memory the file related to the selected CVM (S803). And then, the update determination part 821 of the SAS 183 determines whether MDb of the electronic signature stored in the mac file related to the selected CVM is proper (S804). That is, whether the file name of the mod file related to the selected CVM is proper is determined. Whether MDb is proper can be determined by comparing MDb generated from the file name of the mod file and MDb generated by decoding the electronic signature stored in the mac file by using an open key. After that, the update determination part 821 of the SAS 183 determines whether the MDa of the electronic signature stored in the mac file related to the selected CVM is proper (S805). That is, whether the mod file related to the selected CVM is proper is determined. Whether the MDa is proper can be determined by comparing MDa generated from the mod file and MDa generated by decoding the electronic signature stored in the mac file by using an open key.

The update determination part 821 of the SAS 183 determines that the CVM is used for updating (S811) so as to go to S415 or S515, in a case where “MDb part” and “MDa part” of the electronic signature stored in the mac file related to the selected CVM are proper (divergences 1 and 2).

The update determination part 821 of the SAS 183 determines that the CVM is not used for updating (S812) so as to go to S415 or S515, in a case where “MDb part” and “MDa part” of the electronic signature stored in the mac file related to the selected CVM are not proper (divergences 1 and 2).

The MFP 101 shown in FIG. 1 corresponds to an example of the image forming apparatus of the present invention. An information process implemented by the MFP 101 shown in FIG. 1 corresponds to an example of the information process method of the present invention. SAS 183 shown in FIG. 1 corresponds to an example of the information processing program of the present invention. A CD-ROM, DVD-ROM or SD memory card where the SAS 183 is shown in FIG. 1 corresponds to a recording medium of the present invention.

The present invention is not limited to the above-discussed embodiments, but variations and modifications may be made without departing from the scope of the present invention.

This patent application is based on Japanese Priority Patent Application No. 2004-306960 filed on Oct. 21, 2004, and Japanese Priority Patent Application No. 2005-237850 filed on Aug. 18, 2005, the entire contents of which are hereby incorporated by reference.

What is claimed is:

1. An image forming apparatus where a program can be installed, comprising:
a determination part configured to determine a necessity of confirmation of information with respect to hardware of the image forming apparatus based on the program to be installed, the program stored in a storage medium set in the image forming apparatus or an apparatus connecting to the image forming apparatus via a network; and
a hardware confirmation part configured to confirm the information with respect to the hardware in a case where the determination part determines that the information with respect to the hardware is necessary.

2. The image forming apparatus as claimed in claim 1,
wherein the hardware confirmation part confirms the information with respect to the hardware so as to determine whether the program can be installed.

3. The image forming apparatus as claimed in claim 2, further comprising:
a program selecting part configured to select the program corresponding to the image forming apparatus as an installing object from the program being stored in the storage medium set in the image forming apparatus or the apparatus connecting to the image forming apparatus via the network, in a case where the hardware confirmation part determines that the program can be installed.

4. The image forming apparatus as claimed in claim 3,
wherein the program selecting part selects the program based on identification information included in the program, the identification information being for identifying the image forming apparatus where the program can be used.

5. The image forming apparatus as claimed in claim 4,
wherein the identification information is a file name of the program.

6. The image forming apparatus as claimed in claim 4,
wherein the program selecting part selects the program by comparing the identification information and the information with respect to the hardware that is confirmed by the hardware confirmation part.

7. The image forming apparatus as claimed in claim 1,
wherein the program is a virtual machine for implementing a program not depending on a compiled hardware environment.

8. The image forming apparatus as claimed in claim 1,
wherein the install includes updating of the program.

9. An install method in an image forming apparatus where a program can be installed, the method comprising the steps of:
a) determining a necessity of confirmation of information with respect to hardware of the image forming apparatus based on the program to be installed, the program being stored in a storage medium set in the image forming apparatus or an apparatus connecting to the image forming apparatus via a network; and
b) confirming the information with respect to the hardware in a case where it is determined in the step a) that confirming the information with respect to the hardware is necessary.

10. The install method as claimed in claim 9,
wherein, in the step b), the information with respect to the hardware is confirmed so that whether the program can be installed is determined.

11. The install method as claimed in claim 10, further comprising a step of:
c) selecting the program corresponding to the image forming apparatus as an installing object from the program being stored in the storage medium set in the image forming apparatus or the apparatus connecting to the image forming apparatus via the network, in a case where it is determined in the step b) that the program can be installed.

12. The install method as claimed in claim 11,
wherein the program is selected based on identification information included in the program, the identification information being for identifying the image forming apparatus where the program can be used.

13. The install method as claimed in claim 12,
wherein the identification information is a file name of the program.

14. The install method as claimed in claim 12,
wherein the program is selected by comparing the identification information and the information with respect to the hardware that is confirmed in the step b).

15. The install method as claimed in claim 9,
wherein the program is a virtual machine for implementing a program not depending on a compiled hardware environment.

16. The install method as claimed in claim 9,
wherein the install includes updating of the program.

17. A computer readable recording medium where an install program is recorded, the install program used for installing a program in an image forming apparatus, the install program comprising the steps of:
a) determining a necessity of confirmation of information with respect to hardware of the image forming apparatus based on the program to be installed, the program being stored in a storage medium set in the image forming apparatus or an apparatus connecting to the image forming apparatus via a network; and
b) confirming the information with respect to the hardware in a case where it is determined in the step a) that the information with respect to the hardware is necessary.
